(19) United States
(12) Patent Application Publication
(10) Pub. No.: US 2010/0021123 A1
(43) Pub. Date: Jan. 28, 2010

(54) Method and apparatus for allowing future installation of wires, cables, fibers and the like within a structure.

(76) Inventor: Mike L. Massey, Midland, TX (US)

Correspondence Address: LAW OFFICES OF CHRISTOPHER L. MAKAY, 1634 Milam Building, 115 East Travis Street, San Antonio, TX, 78205, US

(21) Appl. No.: 12/220,375

(22) Filed: Jul. 24, 2008

(51) Int. Cl. G02B 6/00; H02G 3/18

(52) U.S. Cl. 385/138; 174/660

(57) ABSTRACT

A method and apparatus for adding wires, cables, fibers or the like from an accessible part of a structure, such as an attic or crawlspace to an interior room from within the walls of the structure, includes installing a drop tube during the construction of the structure. The drop tube contains an insulating plug to prevent heated or cooled air from escaping prior to installing the wires, cables, fibers or the like. The drop tube is installed through an interior support and extends to an access point, typically behind an interior wall. The drop tube contains flexible barbs or fasteners that both secure the drop tube to like drop tubes so the desired length can be achieved and also allow for the insertion and securing of the drop tube into a penetration hole. At such time when the addition of wire, cable, fibers or the like is desired, the insulation plug is removed and the wires cables, fibers or the like are run through the installed drop tube from the accessible part of the structure to the point where they are needed. To make standard size drop tubes adaptable for penetrating materials of different widths, spacer sleeves can be inserted between the flexible barbs or fasteners and the material to be penetrated to create a secure fit.

### BACKGROUND OF THE INVENTION

1. Field of the Invention

The present invention relates to a method and apparatus for allowing the future installation of wires, cables, fibers or the like within a structure.

2. Description of the Related Art

During the construction phase of commercial and residential structures, in addition to basic electrical wiring, builders must install wires, cables, fiber and other suitable means for sending data or signals, such as cable television, satellite television, telephone, internet or video surveillance feeds throughout the building.

As technology changes and upgrades to existing technology occur, there is often a need to install additional wire, cable, fiber and the like. In the construction of many buildings, provisions are not made for the installation of additional wires, cables and fiber.

In those structures where builders do anticipate this need, limited methods exist to allow for this installation. In the rare situations where this is done, flexible round conduit is installed from a convenience outlet box located within the walls of the structure to run to an accessible area, such as in a crawl space or an attic. This is a cumbersome and costly process, and doing so in this manner allows heat loss at the point of wall penetration due to the inability to insulate the empty conduit.

If there are no provisions made for the installation of wires, cables or fibers, it is a difficult, expensive, labor-intensive and sometimes dangerous job to later add these to a completed structure. An installer must locate the exact area inside the attic or crawl space to drill a penetration hole into the wall cavity where the installer wishes to run the new wire, cable or fiber. Searching for this exact area is time-consuming and may expose the installer to such hazards as dirty insulation, dust, rodent droppings, insects and other contaminants. These may be harmful to the installer, and if the installer tracks these throughout the structure, may be harmful to the inhabitants of the building as well.

In addition, many attics or crawl spaces have insulation to minimize the radiation and convection transfer of heat from the habitable part of the structure. Common insulation methods used are fiberglass blankets (BATT) which are laid down, or blown-in insulation which is dispersed using compressed air. Best results are achieved when the insulation is uniformly dispersed and remains in place. When additional wire, cables or fibers are installed, often insulation must be moved to access the desired wall cavity from above. If the insulation is not replaced properly, the effectiveness of the insulation is reduced, increasing energy use.

Finally, adding additional wire, cables or fibers can be dangerous to both the installer and the structure. Installers must be careful not to step on non-load bearing sections of an attic or crawl space to avoid falling through to a lower floor, which can cause personal injury or death, in addition to property damage. Installers must also avoid drilling penetration holes in the wrong locations, which can damage walls and ceilings. Drilling blindly into a wall or ceiling can also damage existing hidden pipes or wiring, which are expensive to repair of replace and can also result in injury.

Accordingly, a preinstalled, flexible insulated drop tube disposed within an interior wall of a structure with an opening accessible from an attic or crawl space would allowing for the future installation of wires, cables, fibers or the like would be significantly advantageous.

### SUMMARY OF THE INVENTION

In accordance with the present invention, a method and apparatus for allowing the future installation or addition of wire, cables, fiber and the like into the wall spaces of a structure from an attic, crawl space or other accessible area.

In the preferred embodiment, the drop tube would be generally round and cylindrical in shape and made from a flexible material, such as plastic, paper fiber, metal, polyvinyl chloride (PVC), polyethylene, or the like.

The drop tube would have a first end and a second end, with the first end being a “male” end, narrower in diameter than the second end, with the second end being a “female” end, such that two similar drop tubes would be capable of connecting together by telescoping the first end of one drop tube into the second end of a similar drop tube to form a continuous hollow channel for the housing of wires, cables, fiber and the like within. The diameter of first end would be sized to fit snugly within the second end.

In the preferred embodiment, the drop tube would contain sets of radially flexible barbs that perform a dual function. The first function would be the securing of the drop tube into a cavity penetration hole disposed within a structure, typically with the floor of an attic or crawlspace. The cavity penetration hole would be of a sufficient diameter to allow the first end of the drop tube to be inserted. A set of radially flexible barbs would compress as they passed through the cavity penetration hole and flex outward when passing through the top of the cavity penetration hole, preventing the drop tube from being pulled back through the cavity penetration hole. Another set of radially flexible barbs would remain in the flexed outward position and would prevent movement of the drop tube through the cavity penetration hole in the opposite direction, thereby securing the drop tube within the cavity penetration hole.

The second function would be the attachment of the drop tube to another like drop tube. As mentioned earlier, telescoping the first end of one drop tube into the second end of a similar drop tube would form a continuous hollow channel for the housing of wires, cables, fiber and the like within.

This would allow a user to penetrate a wall or attic floor with the drop tube simply by drilling a hole and inserting the drop tube to lock it in place, and to extend the drop tube to the desired length by connecting additional like drop tube pieces to each other.

In alternative embodiments, the drop tube might only have one set of stops as opposed to barbs, which would simply prevent the insertion of the drop tube past the location of the stops. In another embodiment, the drop tube would not need telescope into a like drop tube.

Disposed within the drop tube would be an insulating plug to prevent heated or cooled air loss prior to the installation of the wires, cables, fibers or the like. In the preferred embodiment, the insulating plug would be composed of lightweight expandable foam held in place by compression friction, however, the insulating plug could be composed of any suitable insulating material that could fit within the drop tube and could be held in place by any suitable means capable of being pushed out an opening at the end of the drop tube with a minimum of force during the installation of wires, cable, fiber or the like using any suitable means, such as a stick, wire, fish tape or the like.

The drop tubes could be manufactured in several different sizes with varying distances between the sets of radially flexible barbs to accommodate different thicknesses of material to be penetrated. The drop tubes could also be manufactured in fewer sizes and use “spacer sleeves” to allow a standard size drop tube to be used in several different types of materials of varying thicknesses. The spacer sleeve would be disposed between the material to be penetrated and one of the sets of radially flexible barbs to provide a secure fit.

Typically, in present day situations, large one piece drop tubes are installed and cut down to the desired length. These drop tubes could be manufactured in smaller sizes and diameters than existing drop tubes since a user could add as many drop tubes as necessary to achieve the desired length, decreasing manufacturing, shipping, storage and insulation costs.

It is therefore an object of the present invention to provide an inexpensive drop tube that can be installed into a structure to allow for the future installation of wires, cables and fibers into the structure.

It is a further object of the present invention to provide a preinstalled drop tube that is insulated to prevent the loss of heated or cooled air from the structure.

It is a further object of the present invention to provide drop tube that installs into a cavity penetration hole without tools and without using any separate means to secure it, such as brackets or adhesive.

It is still a further object of the present invention to provide a drop tube that can be manufactured in a small size that can be extended to a desired length by snapping like drop tubes together without using any separate means to secure them together, such as brackets or adhesive.

It is still a further object of the present invention to provide a drop tube that can be manufactured inexpensively in a few standard sizes and be adapted to fit different cavity penetration hole depths through the use of spacer sleeves.

It is still a further object of the present invention to provide a drop tube for the future installation of wires, cables, fibers and the like, that once installed, minimizes disruption to the existing insulation and allows for safer installation.

Still other objects, features, and advantages of the present invention will become evident to those of ordinary skill in the art in light of the following,

### BRIEF DESCRIPTIONS OF THE DRAWINGS

FIG. 1 is a side view of the first embodiment of the drop tube prior to installation.

FIG. 2 is a side partial cross-section view of the second embodiment of the drop tube prior to installation.

FIG. 3 is side view of the second embodiment of the drop tube after installation.

FIG. 4 is a side partial cross-section view of a third embodiment of the drop tube connected to a like drop tube, prior to installation.

FIG. 5 is side view of the third embodiment of the drop tube after installation.

FIG. 6 is a side view of an installed third embodiment of the drop tube with a medium sized spacer sleeve.

FIG. 7 is a side view of an installed third embodiment of the drop tube with a large sized spacer sleeve.

FIG. 8 is a side partial cross-section view of two connected third embodiments of the drop tube after installation, prior to wire installation.

FIG. 9 is a side view of a third embodiment of the drop tube after installation through an attic into a wall space, with a cable installed and passing from the attic, through the drop tube, into the wall space and through a wall.

### DETAILED DESCRIPTION OF THE PREFERRED EMBODIMENTS

Although the disclosure hereof is detailed and exact to enable those skilled in the art to practice the invention, the physical embodiments herein disclosed merely exemplify the invention that may be embodied in other specific structure. While several embodiments have been described, the details may be changed without departing from the invention, which is defined by the claims.

Like referenced characters are used throughout this description to identify like parts.

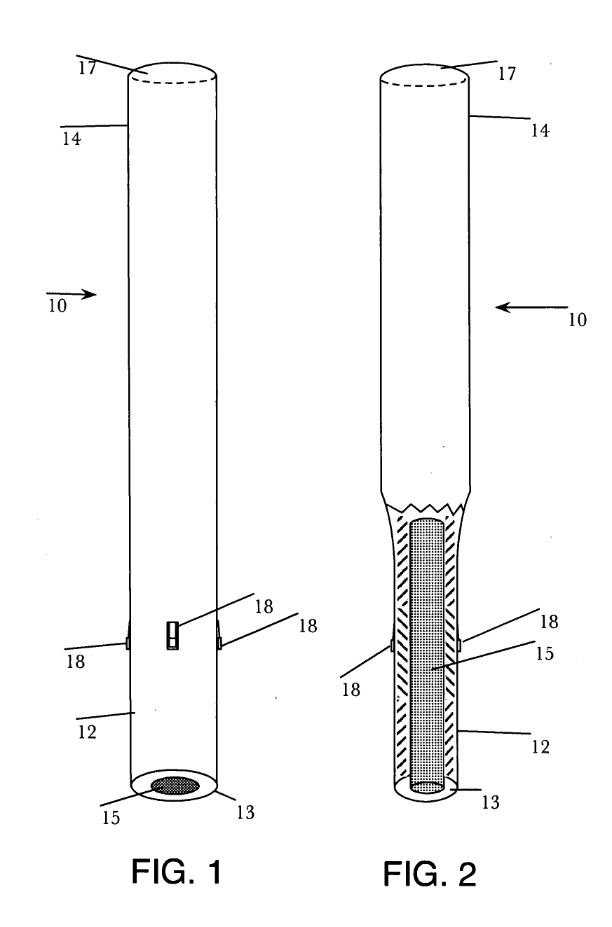

As referenced in FIGS. 1, a first embodiment of a hollow drop tube (generally 10, further referenced as 10a or 10b when more than one like drop tube is used), includes a first end 12 and a second end 14. The drop tube 10 is generally cylindrical in shape.

The first end 12 has an opening 13 disposed within. Disposed within the second end 14 is an opening 17. Disposed within the drop tube 10 is an insulating plug 15. In the preferred embodiment, the insulating plug would be composed of lightweight expandable foam held in place by compression friction, however the insulating plug could be composed of any suitable insulating material that could fit within the drop tube and could be held in place by any suitable means whereby the insulating plug 15 would be held in place securely but would be capable of being pushed out the opening 13 at the end of the drop tube 10 with a minimum of force during the installation of wires, cable, fiber or the like using any suitable means, such as a stick, fish tape or the like.

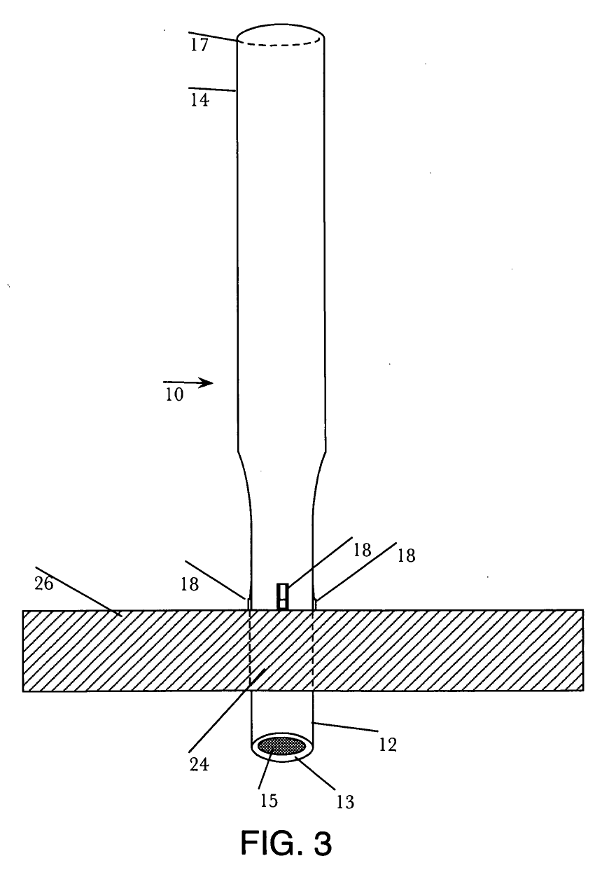

In FIG. 2, a second embodiment of the hollow drop tube 10, includes a first end 12 and a second end 14. The first end 12 has an opening 13 disposed within. Disposed within the second end 14 is an opening 17. Disposed within the drop tube 10 is an insulating plug 15. The second embodiment of drop tube 10 includes the first end 12, which has the opening 13 disposed within, with the first end 12 being a “male” end, narrower in diameter than the second end 14.

In FIG. 3, the second embodiment drop tube 10 is shown inserted into a cavity penetration hole 24 which is disposed within a material to be penetrated, for example, a wood plate 26 in an attic comprised of two 2 by 4 pieces of lumber measuring 3 inches in width. The cavity penetration hole 24 is complimentary in shape to drop tube 10 and is sized to receive the drop tube 10. Disposed within the first end 12 of the drop tube 10 is at least one protruding stop 18. The stop 18 limits the movement of the drop tube 10 through the cavity penetration hole 24 when the stop 18 abuts the plate 26. While the first embodiment of the drop tube 10 shows a set of four stops 18, any number of stops 18—one or more—that will prevent further movement of the drop tube 10 through the cavity penetration hole 24 after insertion is sufficient.

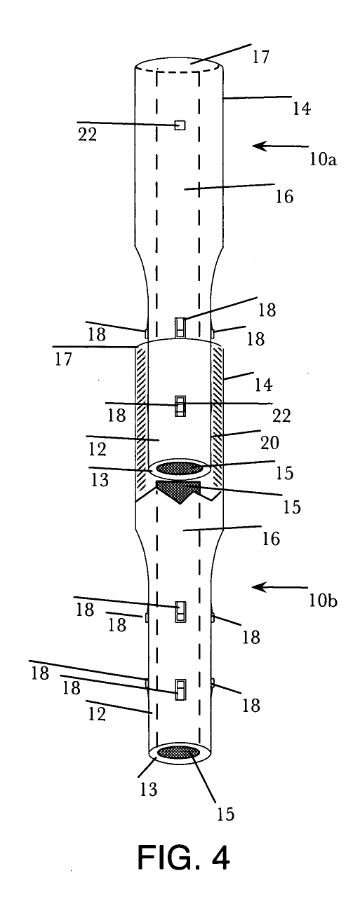

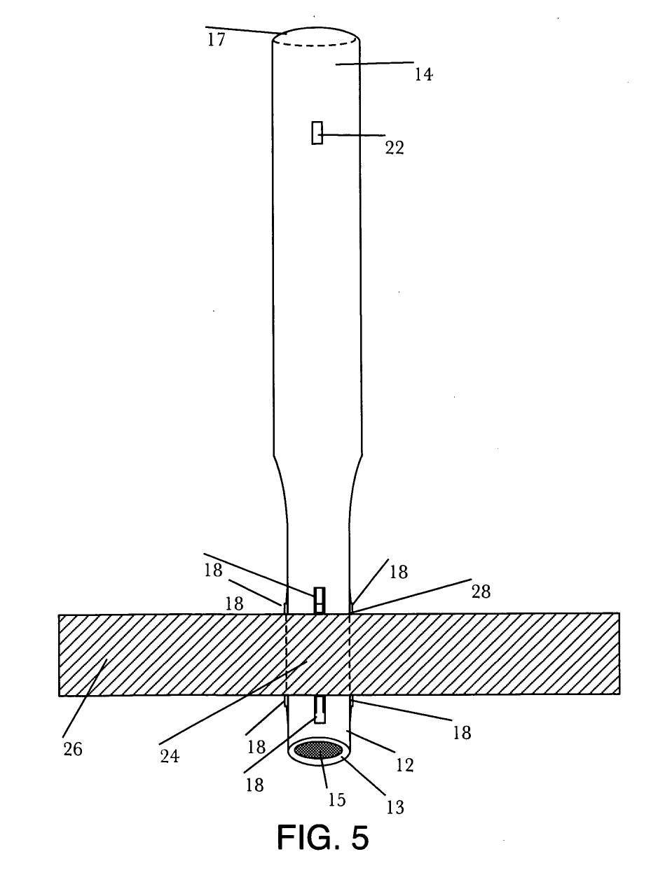

In FIGS. 4 and 5, the third embodiment of the drop tube 10 includes the first end 12, which has the opening 13 disposed within, with the first end 12 being a “male” end, narrower in diameter than the second end 14. The second end 14 has the opening 17 disposed within, with the second end 14 being a “female” end, such that two similar drop tubes 10 would be capable of connecting together by telescoping the first end 12 of a drop tube 10a into the second end 14 of a similar drop tube 10b to form a continuous hollow channel 16 for the housing of wires, cables, fiber and the like within. The diameter of first end 12 would be sized to fit securely within the second end 14 of the drop tube 10.

Disposed within the drop tube 10 is the insulating plug 15. In the preferred embodiment, the insulating plug would be composed of lightweight expandable foam held in place by compression friction, however the insulating plug could be composed of any suitable insulating material that could fit within the drop tube and could be held in place by any suitable means whereby the insulating plug 15 would be held in place securely but would be capable of being pushed out the opening 13 at the end of the drop tube 10 with a minimum of force during the installation of wires, cable, fiber or the like using any suitable means, such as a stick, fish tape or the like.

In the third embodiment, the stops 18 are disposed within the first end 12 of the drop tube 10a. The stops 18 are a set of four radial flexible barbs, configured to engage a set of four openings 22 in the second end 14 of the like drop tube 10b, locking the drop tube 10a to the like drop tube 10b. In the second embodiment, the drop tube 10a contains another set of the stops 18, which are also radial flexible barbs which abut the bottom of the second end 14 of drop tube 10b, further securing the drop tube. It is understood that this number of stops 18 in each set can be higher or lower, depending on the size of the drop tube 10 and the force necessary to attach the drop tube 10 securely.

The first end 12 of the drop tube 10a has at least one stop 18 disposed within, with the stop 18 sized and dimensioned to pass through a telescopable section 20 of the second end 14 of the similar drop tube 10b. Disposed with the second end 14 of a drop tube 10b are openings 22, complimentary in size to the stops 18 of the first end 12, capable of receiving the stop 18 in its extended position. The first end 12 of a drop tube 10 would be inserted into the second end 14 with the stops 18 being flexed radially inwardly by the second end 14, and would then flex radially outwardly when the stops 18 have passed through the telescopable section 20 to align with the openings 22, such that the telescopable section 20 can limit return movement of the stop 18 back through the openings 22 in the second end 14, locking the drop tube 10a to the like drop tube 10b.

In the third embodiment, a set of four stops 18 are disposed within the first end 12 of the drop tube 10a to engage a set of four openings 22 in the second end 14 of the like drop tube 10b, locking the drop tube 10a to the like drop tube 10b. In addition, in the second embodiment, the drop tube 10a contains another set of four stops 18 which abut the bottom of the second end 14 of drop tube 10b, further securing the drop tube. It is understood that this number of stops 18 in each set can be higher or lower, depending on the size of the drop tube 10 and the force necessary to attach the drop tube 10 securely.

As referenced in FIG. 5, in addition to securing the drop tube 10a to the like drop tube 10b, the two sets of stops barbs 18 also serve to secure the drop tube 10 into the cavity penetration hole 24. When inserted into the cavity penetration hole 24 disposed within, for example, the wood plate 26, the first end 12 of the drop tube 10 would pass through the plate opening 28 of the cavity penetration hole 24 with the upper set of the stop 18 being flexed radially inwardly by the wood plate 26, and then would flex radially outwardly when the stops 18 have passed through the wood plate 26, with the lower set of the stops 18 remaining in the outward position and abutting the plate opening 28 of the cavity penetration hole 24, locking the drop tube 10 within the cavity penetration hole 24.

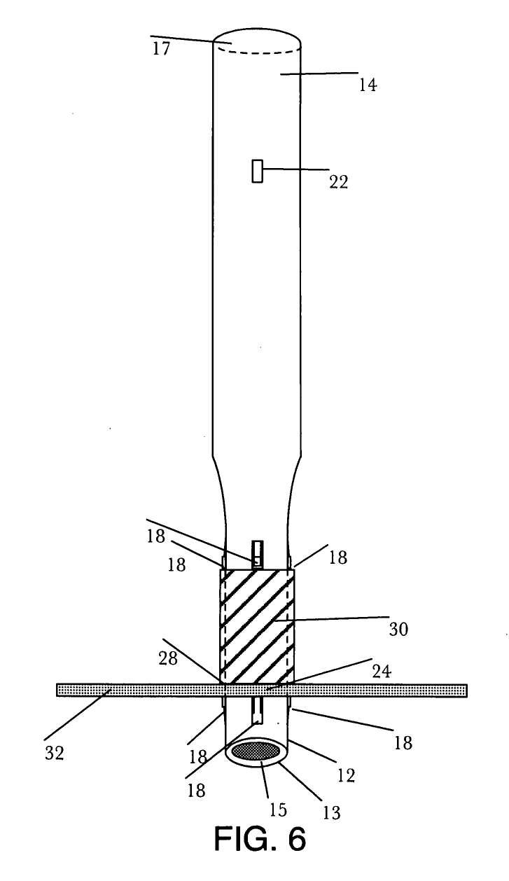

As referenced in FIG. 6, while the distance between the upper and lower sets of radial flexible barbs 18 can be varied to accommodate different widths of material in which the cavity penetration hole 24 is disposed within, a spacer sleeve 30 can also be used to accommodate different widths of material. If the preferred embodiment the drop tube 10 is comprised of a 3 inch space between its upper and lower sets of radial flexible barbs 18, to use drop tube 10 to penetrate a one-half inch thick piece of sheetrock 32, a two and one-half inch thick spacer sleeve 30 would be used to abut the lower part of the cavity penetration hole 24 and the lower sets of radial flexible barbs 18 to secure the drop tube 10 in place.

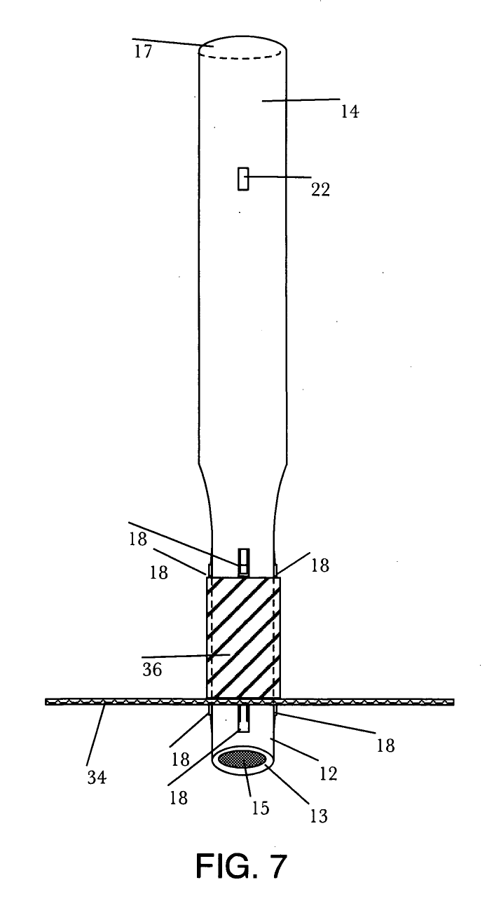

As referenced in FIG. 7, to use the drop tube 10 to penetrate a one-eighth inch thick 16 gauge steel plate 34, a two and seven-eights inch thick spacer sleeve 36 would be used to abut the lower part of the cavity penetration hole 24 (not shown) and the lower sets of radial flexible barbs 18 to secure the drop tube 10 in place.

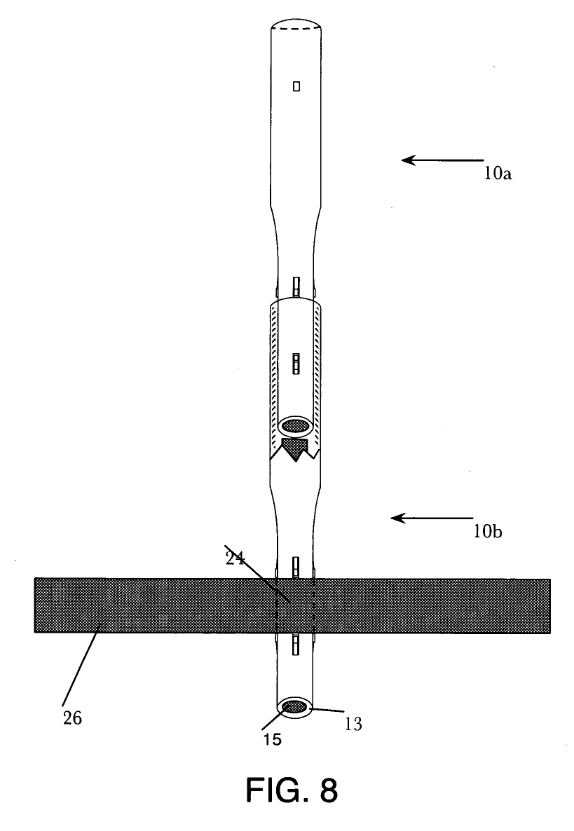

As referenced in FIG. 8, the drop tube 10b is installed into the plate 26 through the cavity penetration hole 24 and is secured to the drop tube 10a. While the drop tube 10a and the 10b are shown, an unlimited number of the drop tubes 10 may be secured to each other to achieve a desired length. To prepare the drop tube 10 for installation of wires, cables, fibers and the like, the insulation plug 15 would be removed from the drop tube 10 by pushing it through the opening 17 using a suitable means, such as a stick or fish tape.

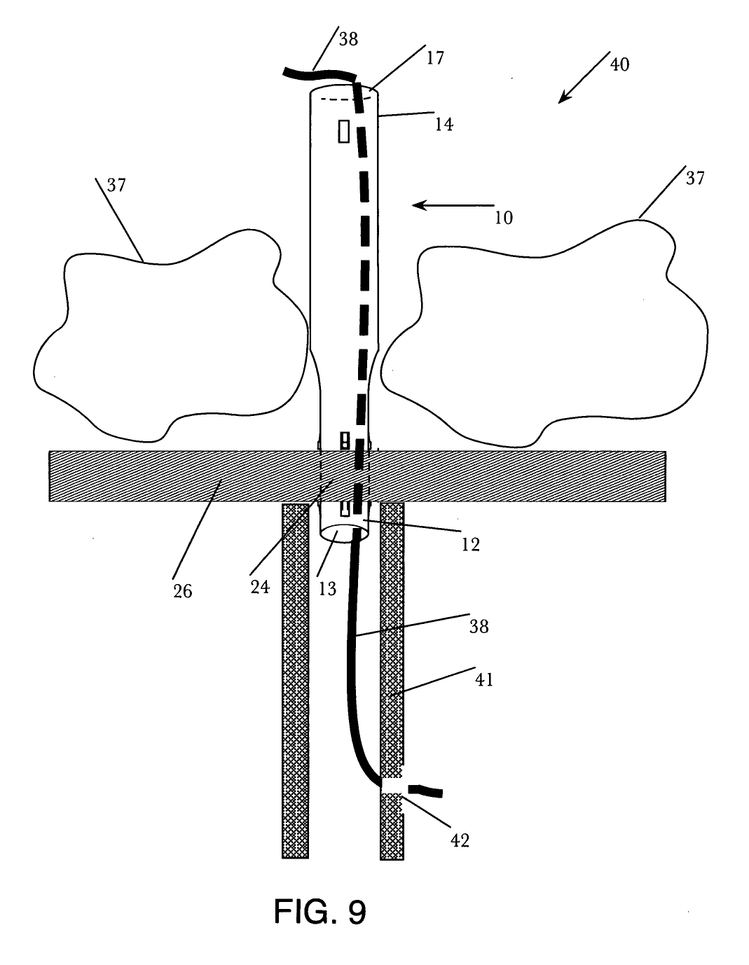

As referenced in FIG. 9, the drop tube 10 is installed into a plate 26 in an attic 40, protruding beyond an insulation 37 through the cavity penetration hole 24. The drop tube 10 has had the insulating plug 15 removed (not shown) as described in FIG. 8. While a single drop tube 10 is shown, an unlimited number of the drop tubes 10 may be secured to each other to achieve a desired length for access through the attic 40 to be accessible through a wall 41. A cable 38 is installed by inserting the cable 38 through the opening 13 in first end 12. The cable 38 is pushed through until it exits at the opening 17 at the second end 14. From the opening 17, the cable 38 would exit drop tube 10 and connect to a wall access 42, which could be a penetration hole, an outlet, junction box or any other suitable means to receive cable 38.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. Although the present invention has been described in terms of the foregoing preferred embodiments, such description has been for exemplary purposes only and, as will be apparent to those of ordinary skill in the art, many alternatives, equivalents, and variations of varying degrees will fall within the scope of the present invention. That scope, accordingly, is not to be limited in any respect by the foregoing detailed description; rather, it is defined only by the claims that follow.

1. An apparatus for allowing the future installation of wires, cables, fibers, and the like within a structure, comprising:
a drop tube, including a first end, a second end, and a hollow interior; and
a stop disposed on the drop tube, whereby the stop secures the drop tube in a penetration aperture disposed in a section of the structure such that the drop tube communicates from a first space of the structure to a second space of the structure.

2. The apparatus for allowing the future installation of wires, cables, fibers, and the like within a structure according to claim 1, wherein the drop tube provides a pathway for wires, cables, fibers and the like to be run from the first space of the structure to the second space of the structure.

3. The apparatus for allowing the future installation of wires, cables, fibers, and the like within a structure according to claim 1, wherein the stop abuts the section of the structure containing the penetration aperture, thereby preventing movement of the drop tube through the penetration aperture.

4. The apparatus for allowing the future installation of wires, cables, fibers, and the like within a structure according to claim 3, further comprising a radially flexible barb disposed on the drop tube nearer the first end than the stop, wherein the radially flexible barb flexes radially inward as the radially flexible barb passes through the penetration aperture, further wherein the radially flexible barb flexes radially outward as the radially flexible barb exits the penetration aperture, thereby securing the drop tube within the penetration aperture.

5. The apparatus for allowing the future installation of wires, cables, fibers, and the like within a structure according to claim 4, wherein the stop and the radially flexible barb may be spaced apart to accommodate penetration apertures of varying depth.

6. The apparatus for allowing the future installation of wires, cables, fibers, and the like within a structure according to claim 4, further comprising a spacing sleeve disposed between the stop and the section of the structure containing the penetration aperture to accommodate penetration apertures of varying depth.

7. The apparatus for allowing the future installation of wires, cables, fibers, and the like within a structure according to claim 1, wherein the first end the drop tube is a “male” end, narrower in diameter than the second end, with the second end being a “female” end.

8. The apparatus for allowing the future installation of wires, cables, fibers, and the like within a structure according to claim 7, wherein a first drop tube may connect together with a second drop tube by telescoping the first end of the first drop tube into the second end of second drop tube, thereby forming a continuous hollow channel through the connected first and second drop tubes.

9. The apparatus for allowing the future installation of wires, cables, fibers, and the like within a structure according to claim 8, wherein the stop of the first drop tube abuts the second end of second drop tube.

10. The apparatus for allowing the future installation of wires, cables, fibers, and the like within a-structure according to claim 9, wherein the second end of the second drop tube includes an opening therethrough.

11. The apparatus for allowing the future installation of wires, cables, fibers, and the like within a structure according to claim 10, further comprising a radially flexible barb disposed on the first drop tube nearer the first end than the stop, wherein the radially flexible barb flexes radially inward as the radially flexible barb enters the second end of the second drop tube, further wherein the radially flexible barb flexes radially outward as the radially flexible barb encounters the opening in the second drop tube, thereby securing the first drop tube within the second drop tube.

12. The apparatus for allowing the future installation of wires, cables, fibers, and the like within a structure according to claim 1, further comprising an insulator adapted to fit within the hollow channel of the drop tube.

13. The apparatus for allowing the future installation of wires, cables, fibers, and the like within a structure according to claim 12, wherein the insulator is of lightweight expandable foam held in place by compression friction, and capable of being detached and pushed through the opening of the second end by applying force through the opening at the first end.

14. An apparatus for allowing the future installation of wires, cables, fibers, and the like within a structure, comprising:
a drop tube, including a first end, a second end, and a hollow interior, whereby the drop tube is securable in a penetration aperture disposed in a section of the structure such that the drop tube communicates from a first space of the structure to a second space of the structure; and
an insulator adapted to fit within the hollow channel of the drop tube.

15. The apparatus for allowing the future installation of wires, cables, fibers, and the like within a structure according to claim 14, wherein the insulator is of lightweight expandable foam held in place by compression friction, and capable of being detached and pushed through the opening of the second end by applying force through the opening at the first end.

16. The apparatus for allowing the future installation of wires, cables, fibers, and the like within a structure according to claim 14, wherein the drop tube provides a pathway for wires, cables, fibers and the like to be run from the first space of the structure to the second space of the structure.

17. The apparatus for allowing the future installation of wires, cables, fibers, and the like within a structure according to claim 14, further comprising a stop disposed on the drop tube, whereby the stop abuts the section of the structure containing the penetration aperture, thereby preventing movement of the drop tube through the penetration aperture.

18. The apparatus for allowing the future installation of wires, cables, fibers, and the like within a structure according to claim 17, further comprising a radially flexible barb disposed on the drop tube nearer the first end than the stop, wherein the radially flexible barb flexes radially inward as the radially flexible barb passes through the penetration aperture, further wherein the radially flexible barb flexes radially outward as the radially flexible barb exits the penetration aperture, thereby securing the drop tube within the penetration aperture.

19. The apparatus for allowing the future installation of wires, cables, fibers, and the like within a structure according to claim 18, wherein the stop and the radially flexible barb may be spaced apart to accommodate penetration apertures of varying depth.

20. The apparatus for allowing the future installation of wires, cables, fibers, and the like within a structure according to claim 18, further comprising a spacing sleeve disposed between the stop and the section of the structure containing the penetration aperture to accommodate penetration apertures of varying depth.

21. The apparatus for allowing the future installation of wires, cables, fibers, and the like within a structure according to claim 14, wherein the first end the drop tube is a “male” end, narrower in diameter than the second end, with the second end being a “female” end.

22. The apparatus for allowing the future installation of wires, cables, fibers, and the like within a structure according to claim 21, wherein inserting the first end the drop tube into the penetration aperture secures the drop tube in the penetration aperture.

23. The apparatus for allowing the future installation of wires, cables, fibers, and the like within a structure according to claim 21, wherein a first drop tube may connect together with a second drop tube by telescoping the first end of the first drop tube into the second end of second drop tube, thereby forming a continuous hollow channel through the connected first and second drop tubes.

24. The apparatus for allowing the future installation of wires, cables, fibers, and the like within a structure according to claim 23, further comprising a stop disposed on the first drop tube, wherein the stop of the first drop tube abuts the second end of second drop tube.

25. The apparatus for allowing the future installation of wires, cables, fibers, and the like within a structure according to claim 24, wherein the second end of the second drop tube includes an opening therethrough.

26. The apparatus for allowing the future installation of wires, cables, fibers, and the like within a structure according to claim 25, further comprising a radially flexible barb disposed on the first drop tube nearer the first end than the stop, wherein the radially flexible barb flexes radially inward as the radially flexible barb enters the second end of the second drop tube, further wherein the radially flexible barb flexes radially outward as the radially flexible barb encounters the opening in the second drop tube, thereby securing the first drop tube within the second drop tube.

27. A method of installing a drop tube that allows for the future installation of wires, cables, fibers, and the like within a structure, comprising:
constructing a structure comprising a first space and a second space;
creating a penetration aperture in the structure that creates an opening from the first space to the second space; and
securing a drop tube in the penetration aperture such that a first end of a drop tube is accessible in the first space of the structure a second end of the drop tube communicates with the second space of the structure, thereby providing a passageway between the first and second spaces of the structures.

28. The method of installing a drop tube that allows for the future installation of wires, cables, fibers, and the like within a structure according to claim 27, further comprising inserting an insulator into the drop tube.

29. The method of installing a drop tube that allows for the future installation of wires, cables, fibers, and the like within a structure according to claim 27, further comprising lengthening the drop tube by attaching an additional drop tube to the drop tube in the penetration aperture.

30. The method of installing a drop tube that allows for the future installation of wires, cables, fibers, and the like within a structure according to claim 27, further comprising:
removing the insulator from the drop tube, and
running wires, cables, fibers and the like from the first space of the structure into the second space of the structure employing the drop tube.
